(19) United States
(12) Patent Application Publication
(10) Pub. No.: US 2006/0091199 A1
(43) Pub. Date: May 4, 2006

(54) Retrieving information on material used in solid freeform fabrication

(76) Inventor: Stephen A. Loughran, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/976,637

(22) Filed: Oct. 29, 2004

(51) Int. Cl. G06F 7/00

(52) U.S. Cl. 235/376

(57) ABSTRACT

In a method of an embodiment of the invention, a solid freeform fabrication (SFF) system receives a unique material identifier from a material container. In response to determining that a material associated with the unique material identifier is known to the SFF system, the SFF retrieves information regarding the material from over a network, based on the unique material identifier with which the material is associated.

### BACKGROUND OF THE INVENTION

Solid freeform fabrication (SFF) encompasses technologies that are employed to fabricate physical objects directly from computer-aided drafting (CAD) data sources. SFF is also referred to as freeform fabrication (FFF), rapid prototyping, and layered manufacturing. In SFF, physical objects are fabricated in a layer-by-layer manner. The material of each layer is bonded to the material of the immediately adjacent layers. Such additive technology provides for advantages over classic subtraction fabrication methods such as milling. For instance, objects can be formed with any geometric complexity or intricacy without the need for elaborate machine setup or final assembly. Furthermore, the construction of complex objects is reduced to a manageable, straightforward, and relatively fast process. Engineers, surgeons, architects, and artists, among other disciplines, routinely use SFF.

The materials from which SFF systems of SFF fabricators can fabricate physical objects can have different types of information. For example, melting temperature, storage temperature, minimum feature size, horizontal and vertical shrinkage rates, material lifetime, inter-layer delay time, and amount of ultraviolet (UV) light required per layer, among other types of information, can vary from material to material. SFF systems thus have to be updated in order to accommodate new materials. Some types of information are also needed by client devices of users, such as the computing devices like desktop computers that run CAD software which generate the SFF fabrication jobs in accordance with which physical objects are constructed by the SFF systems. For instance, build time estimation, feature orientation suggestion, and part scaling based on expected shrinkage are determinations that the CAD software makes based on information of the expected material from which a physical object is to be constructed.

Updating both SFF systems of SFF fabricators, as well as client devices of users, can be a laborious process. Typically, the SFF systems, and sometimes the client devices, are hard coded with the information of the materials, such that the introduction of information regarding new materials into the systems and the devices is difficult to accomplish. Even if the SFF systems and client devices are soft coded with the information of the materials, users may have to remember to perform updates to retrieve information regarding new materials. Furthermore, information regarding already known materials can change over time.

### BRIEF DESCRIPTION OF THE DRAWINGS

The drawings referenced herein form a part of the specification. Features shown in the drawing are meant as illustrative of only some embodiments of the invention, and not of all embodiments of the invention.

FIG. 1 is a diagram of a rudimentary system, including two solid freeform fabrication (SFF) systems, and a material information server, in which the SFF systems are able to retrieve information regarding materials from the material information server according to an embodiment of the invention.

FIG. 2 is a diagram depicting how a Uniform Resource Locator (URL) address at which information regarding a material can be downloaded can be fabricated based on a known base URL address and a unique material identifier of the material, according to an embodiment of the invention.

FIG. 3 is a flowchart of a method performable by an SFF system to obtain information regarding a material based on a material identifier of the material, according to an embodiment of the invention.

FIG. 4 is a flowchart of a method performable by an SFF system to obtain information regarding a material based on a material identifier of the material, according to an embodiment of the invention.

FIG. 5 is a block diagram of an SFF system in detail, according to an embodiment of the invention.

FIG. 6 is a block diagram of another SFF system in detail, according to an embodiment of the invention.

### DETAILED DESCRIPTION OF THE DRAWINGS

In the following detailed description of exemplary embodiments of the invention, reference is made to the accompanying drawings that form a part thereof, and in which is shown by way of illustration specific exemplary embodiments in which the invention may be practiced. These embodiments are described in sufficient detail to enable those skilled in the art to practice the invention. Other embodiments may be utilized, and logical, mechanical, electrical, electro-optical, software/firmware and other changes may be made without departing from the spirit or scope of the present invention. The following detailed description is, therefore, not to be taken in a limiting sense, and the scope of the present invention is defined only by the appended claims.

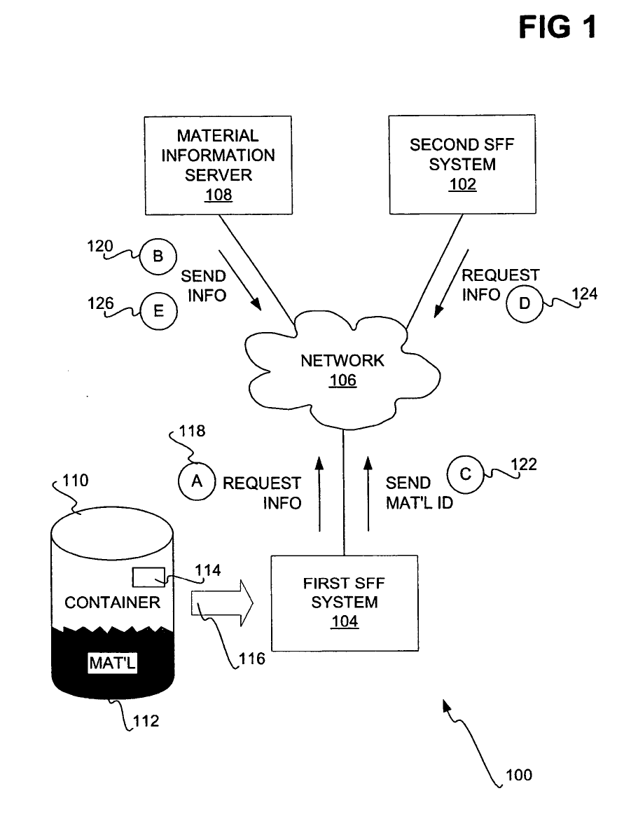

FIG. 1 shows an overview of a system 100, according to an embodiment of the invention. Other aspects of the system 100 in various embodiments thereof are described in relation to subsequent figures of the drawings. The system 100 includes a first solid freeform fabrication (SFF) system 102, a second solid freeform fabrication (SFF) system 104, and a material information server 108, which are communicatively coupled to one another via a network 106. Each of the first SFF system 102 and the material information server 108 may be or include a general-purpose computing device, like a desktop, portable, or server computer running computer-aided drafting (CAD) software. The first SFF system 102 and the material information server 108 may also each be another type of device other than a general-purpose computing device. In some embodiments of the invention, the first SFF system 102 may be considered a client to the second SFF system 104, in that the first SFF system 102 provides SFF jobs to the second SFF system 104, and the second SFF system 104 fabricates these jobs. Only one such client is depicted in FIG. 1 for illustrative convenience, and in other embodiments there may be more than one such client. Furthermore, the network 106 may be or include one or more of: the Internet, an intranet, an extranet, a wired network, a wireless network, and a telephony network, among other types of networks.

The second SFF system 104 fabricates physical objects from SFF fabrication jobs in a layer-by-layer manner. SFF may also be referred to as freeform fabrication (FFF), rapid prototyping, and layered manufacturing, and these terms are used interchangeably and synonymously herein. The second SFF system 104 may be or include in particular one or more of: a selective laser sintering SFF system, a stereo lithography SFF system, a wide-area thermal inkjet SFF system, a fused deposition modeling SFF system, a single jet inkjet SFF system, a three-dimensional printing SFF system, and a laminated object manufacturing SFF system, among other types of SFF systems. Each of these different types of SFF systems is now briefly described.

In a selective laser sintering SFF system, a roller spreads thermoplastic powder over the surface of a build cylinder. The piston in the cylinder moves down one object layer thickness to accommodate the new layer of powder. The powder delivery system is similar in function to the build cylinder. A piston moves upward incrementally to supply a measured quantity of powder for each layer. A laser beam is then traced over the surface of this tightly compacted powder to selectively melt and bond it to form a layer of the object. The fabrication chamber is maintained at a temperature just below the melting point of the powder so that heat from the laser need only elevate the temperature slightly to cause sintering. The process is repeated until the entire object is fabricated.

In a stereo lithography SFF system, plastic objects are built a layer at a time by tracing a laser beam on the surface of a vat of liquid photopolymer. This class of materials quickly solidifies wherever the laser beam strikes the surface of the liquid. Once one layer is completely traced, it is lowered a small distance into the vat and a second layer is traced right on top of the first. The self-adhesive property of the material causes the layers to bond to one another and eventually form a complete, three-dimensional object after many such layers are formed.

In a wide-area thermal inkjet or a single jet inkjet SFF system, a jet for each of a plastic build material and a wax-like support material is used. The materials are held in a melted liquid state in reservoirs. The liquids are fed to individual jetting heads that squirt tiny droplets of the materials in the required pattern as they are moved to form a layer of the object. The materials harden by rapidly dropping in temperature as they are deposited. After jetting forms an entire layer of the object, a milling head is passed over the layer to make it a uniform thickness. Particles are vacuumed away as the milling head cuts and are captured in a filter. The process is repeated to form the entire object.

In a fused deposition modeling SFF system, a plastic filament is unwound from a coil and supplies material to an extrusion nozzle. The nozzle is heated to melt the plastic and has a mechanism that allows the flow of the melted plastic to be turned on and off. The nozzle is mounted to a mechanical stage that can be moved in both horizontal and vertical directions. As the nozzle is moved over the table in the required geometry, it deposits a thin bead of extruded plastic to form each layer. The plastic hardens immediately after being squirted from the nozzle and bonds to the layer below. The entire system is contained within a chamber that is held at a temperature just below the melting point of the plastic.

In a three-dimensional printing SFF system, a layer of powder object material is deposited at the top of a fabrication chamber. To accomplish this, a measured quantity of powder is first dispensed from a similar supply chamber, such as by moving a piston upward incrementally. A roller then distributes and compresses the powder at the top of the fabrication chamber. A multi-channel jetting head subsequently deposits a liquid adhesive in a two dimensional pattern onto the layer of the powder which becomes bonded in the areas where the adhesive is deposited, to form a layer of the object. Once a layer is completed, the fabrication piston moves down by the thickness of a layer, and the process is repeated until the entire object is formed within the powder bed. After completion, the object is elevated and the extra powder removed.

In a laminated object manufacturing SFF system, profiles of object cross sections are cut from paper or other web material using a laser. The paper is unwound from a feed roll onto the stack and first bonded to the previous layer using a heated roller that melts a plastic coating on the bottom side of the paper. The profiles are then traced by an optics system that is mounted to a stage. After cutting of the layer is complete, excess paper is cut away to separate the layer from the web. Waste paper is wound on a take-up roll. Areas of cross sections that are to be removed in the final object are heavily crosshatched with the laser to facilitate removal.

Still referring to FIG. 1, a material container 110 containing a material 112 from which physical objects can be fabricated at the second SFF system 104 in accordance with SFF fabrication jobs generated at the first SFF system 102 is introduced into the second SFF system 104, as indicated by the arrow 116. The material 112 may be a new, and thus unknown, or already known material. The material container 110 contains a tag 114 that includes a material identifier that is unique among material identifiers of different containers containing other materials. Based on the material identifier of the tag 114, the second SFF system 104 is able to recognize the material 112 being introduced thereinto, and determine whether the material 112 is an already known material, or a new and unknown material.

For instance, in one embodiment, the tag 114 may be a radio-frequency identfier (RFID) tag that returns a signal encoding the unique material identifier of the material 112 when sent a transmitting signal. The second SFF system 104 in such an embodiment detects the signal, and decodes the unique material identifier from the signal. In another embodiment, the tag 114 may be a bar code tag having a bar code encoding the unique material identifier of the material 112. The second SFF system 104 in this embodiment scans the bar code, and decodes the unique material identifier from the bar code. In a different embodiment, the tag 114 may have the unique material identifier of the material 112 printed thereon. The second SFF system 104 may therefore have optical character recognition (OCR) capabilities to recognize the unique material identifier, or the second SFF system 104 may prompt the user of the second SFF system 104 to manually enter the unique material identifier into the second SFF system 104, such as by using an input device like a keyboard.

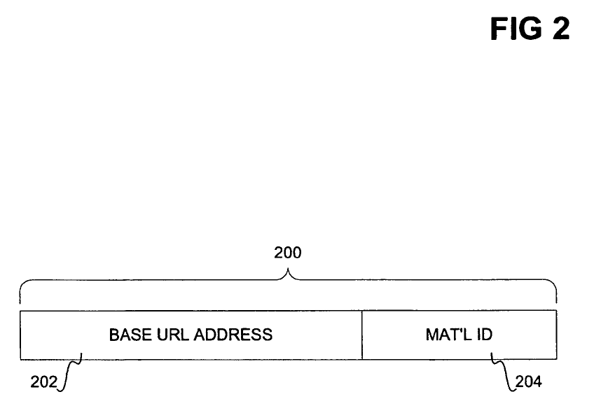

If the unique material identifier is unknown to the second SFF system 104, or if the second SFF system 104 determines that it needs to update its information regarding the material 112 having this unique material identifier, then the second SFF system 104 requests the information regarding the material 112 from the material information server 108 over the network 106, as indicated by the letter A 118. The information may be requested based on the unique material identifier with which the material 112 is associated. One particular manner by which the information is requested is described later in the detailed description in relation to FIG. 2.

In response to the request, the material information server 108 sends the information regarding the material 112 back to the second SFF system 104 over the network 106, as indicated by the letter B 120, such that it can be said that the second SFF system 104 has retrieved the information regarding the material 112 from the material information server 108. The material information server 108 may be managed by the manufacturer or distributor of the material 112, for instance. The second SFF system 104 stores the information regarding the material 112 that has been retrieved, and also stores the unique material identifier associated with the material 112, such that the material 112 is now considered as being known. The second SFF system 104 can now employ the information regarding the material 112 when fabricating physical objects from the material 112 in accordance with SFF fabrication jobs received from the first SFF system 102.

The type and format of the information retrieved by the second SFF system 104 from the material information server 108 regarding the material 112 can vary. For instance, the information retrieved by the second SFF system 104 regarding the material 112 may include information in a machine-readable format that is not readily understood by users, and by which the second SFF system 104 is automatically and dynamically adjusted for utilization with the material 112. Such information may include parameters of the material 112, including, but not limited to, melting temperature, storage temperature, minimum feature size, horizontal and vertical shrinkage rates, material lifetime, inter-layer delay time, and amount of ultraviolet (UV) light required per layer, among other parameters.

The information retrieved by the second SFF system 104 regarding the material 112 may also include information in a human-readable format readily understood by users, and intended primarily for user education regarding the material 112 and not for utilization by the second SFF system 104. For instance, such information may include material data sheet (MDS) information regarding the material 112, including safety, storage, and other information that is more pertinent to the users of the second SFF system 104 than to the second SFF system 104 when the second SFF system 104 fabricates physical objects from the material 112. Thus, the information retrieved from the material information server 108 regarding the material 112 may be both information on which basis the second SFF system 104 dynamically adjusts its own parameters for fabricating physical objects from the material 112, as well as information intended for user education. These parameters may include the operating temperature that the second SFF system 104 needs to achieve to melt the material, the temperature that the second SFF system 104 needs to maintain to store the material, the length of time to wait after one layer of the material has been fabricated before processing the next layer, and so on.

Because the integrity of the information regarding the material 112 is important for the second SFF system 104 to be able to properly fabricate physical objects from the material 112, the second SFF system 104 can verify the authenticity of the information in one embodiment of the invention. For instance, this may be accomplished by retrieving the information from the material information server 108 via a secure server connection, such as a secure socket layer (SSL) connection. As such, the second SFF system 104 can reliably verify the identity of the material information server 108, such that the material information server 108 is considered a trusted source of the information regarding the material 112 that the second SFF system 104 acquires therefrom. In another embodiment, the document, or file, containing the information regarding the material 112 can be digitally signed. For example, an extensible Markup Language (XML) document, or file, can be signed internally, as known within the art. Thus, such a document, or file, can be authenticated independently of how the recipient of the document, or file, obtains it.

The first SFF system 102 may also want to receive the information regarding the material 112. For instance, the first SFF system 102 may have CAD software running thereon to generate SFF fabrication jobs outlining the fabrication of physical objects by the second SFF system 104 from materials, like the material 112. The first SFF system 102, such as its CAD software, may have to have the information regarding the material 112 so that the SFF fabrication jobs can be accurately generate for ultimate fabrication of physical objects from the material 112. For instance, build time estimation, feature orientation suggestion, and part scaling based on expected shrinkage are determinations that the CAD software may make based on the information regarding the material 112 from which a physical object is to be constructed.

In one embodiment, therefore, the first SFF system 102 requests the information regarding the material 112 from the material information server 108 over the network 106 based on the unique material identifier of the material 112, as indicated by the letter D 124. The second SFF system 104 may have already sent the material identifier for the material 112 to the first SFF system 102, as indicated by the letter C 122, such that the first SFF system 102 requests this information only if it does not already have it. The material information server 108 sends the information back to the first SFF system 102 over the network 106, as indicated by the letter E 126. The first SFF system 102 may receive the unique material identifier of the material 112 from the second SFF system 104, and compare it against a list of material identifiers known to the first SFF system 102, to determine whether it needs to retrieve the information regarding the material 112 from the material information server 108. Furthermore, the first SFF system 102 may periodically retrieve the information regarding each of its known materials, such as the material 112, to update stored information. In another embodiment, the first SFF system 102 may receive the information regarding the material 112 from the second SFF system 104, instead of from the material information server 108. It is noted that the terminology “list” as used herein is meant in an encompassing and general manner, and is not meant to convey that embodiments of the invention are restricted to a particular type of data structure, such as a list. As such, other types of data structures can be employed as well, such as arrays, objects, linked lists and so on.

FIG. 2 shows a Uniform Resource Locator (URL) address 200 that can be formulated by the second SFF system 104 to download the information regarding the material 112 from the material information server 108 over the network 106, according to an embodiment of the invention. It is noted that the manner by which information can be downloaded, as is described in relation to FIG. 2, is applicable to one embodiment of the invention. In other embodiments of the invention, information can be downloaded in other manners, as can be appreciated by those of ordinary skill within the art. That is, the manner by which information can be downloaded, as described in relation to FIG. 2, is an exemplary such approach for downloading information, and other embodiments of the invention are not limited to this approach. The URL address 200 identifies a location of the information regarding the material 112 on the material information server 108 that is accessible to the second SFF system 104 over the network 106, where the network 106 is or includes the Internet, an intranet, and/or other like network. Thus, the second SFF system 104 may employ Internet-accessing technology (e.g., TCP/IP or other like protocol-based systems) to retrieve the information regarding the material 112 at the URL address 200 of the material information server 108.

Exemplary URL address 200 includes a base URL address 202 and the material identifier 204 of the material 112 that was, for example, retrieved from the tag 114 of the material container 110. The base URL address 202 may be pre-known or otherwise provided to the second SFF system 104. In this example, to construct or formulate the URL address 200, the second SFF system 104 appends the material identifier 204 to the base URL address to obtain the URL address 200 at which it is able to download the information regarding the material 112 from the material information server 108 over the network 106.

For example, the base URL address 202 may be “http://www.materials.example.com/MaterialInfoByID/” and the material identifier 204 of the material 112 retrieved from the tag 114 of the material container 110 may be “101785”. Therefore, the URL address 200 is constructed as “http://www.materials.example.com/MaterialInfoByID/101785”, at which location of the material information server 108 the second SFF system 104 is able to retrieve the information regarding the material 112. In an alternative embodiment, the second SFF system 104 may further append a known suffix to the material identifier 204, such as “.xml”, rendering the resulting URL address as “http://www.materials.example.com/MaterialInfoByID/101785.xml”, for instance. In an alternative embodiment, there may be a single constant URL for all documents, or files, and the retrieval request may include an identifier of the material in the body, or payload, of the request. For example, if the Simple Object Access Protocol (SOAP) is used as the communications protocol, the material identifier can be included in XML contents of a HyperText Transport Protocol (HTTP) POST request.

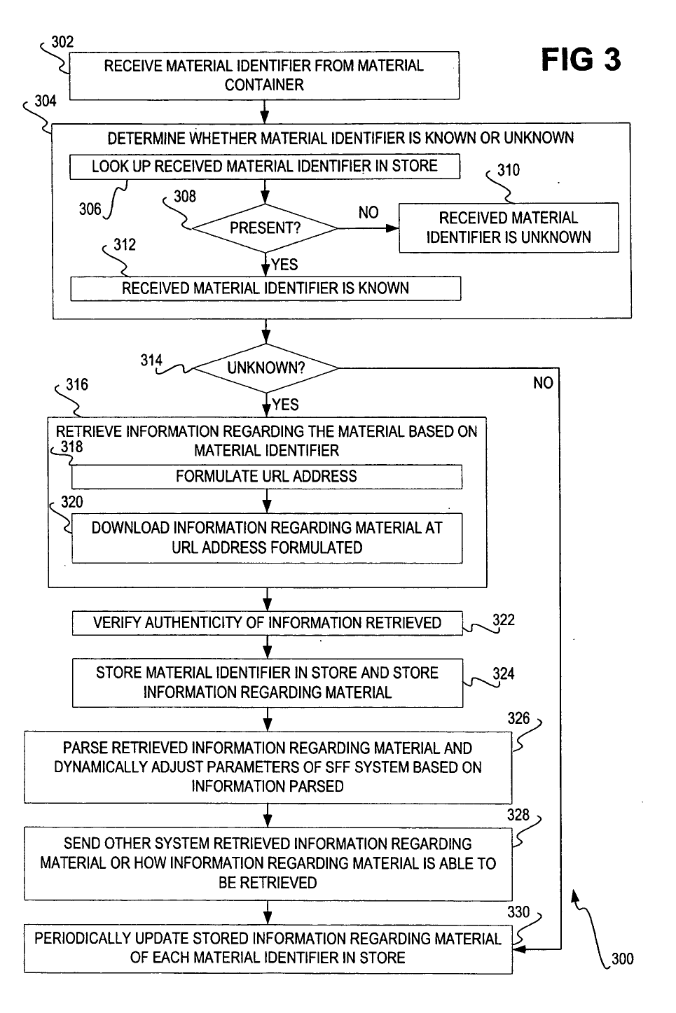

FIG. 3 shows a method 300 that is performable by the second SFF system 104, according to an embodiment of the invention. The second SFF system 104 is described as performing the method 300 relative to the first SFF system 102, the material information server 108, the material container 110, the material 112, the tag 114, and the network 106 of FIG. 1, for descriptive clarity. The method 300 may be implemented as one or more computer program parts of a computer program stored on a computer-readable medium. The medium may be a recordable data storage medium, a modulated carrier signal, or another type of computer-readable medium.

The second SFF system 104 receives the material identifier from the tag 114 of the material container 110 (302). The material identifier is unique to and associated with the material 112 contained in the container 110. Receiving the material identifier can include detecting a signal returned by the tag 114, where it is an RFID tag, and where the signal encodes the material identifier. Alternatively, receiving the material identifier can include scanning the tag 114, where it is a bar code tag having a bar code encoding the material identifier. Furthermore, receiving the material identifier can include prompting a user to manually enter the material identifier as printed on the tag 114, or by performing OCR relative to the material identifier printed on the tag 114.

The second SFF system 104 determines whether the material identifier is known or unknown to it (304). This can involve looking up the material identifier in a store of known material identifiers, each associated with a different material (306). If the material identifier received is not present in the store (308), then the second SFF system 104 concludes that the material identifier is unknown to it (310). Otherwise, the second SFF system 104 concludes that the material identifier is known to it (312).

If the material identifier is unknown (314), then the second SFF system 104 retrieves information regarding the material 112 from the material information server 108 over the network 106, based on the material identifier (316). This can involve formulating a URL address as has been described (318), based on a known base URL address and appending thereto the received material identifier. The information regarding the material 112 is then downloaded from the material information server 108 at the URL address formulated (320). The information may include machine-readable information by which the second SFF system 104 is to be dynamically adjusted for using the material 112, and/or human-readable information that the second SFF system 104 is capable of displaying to a user for education regarding the material 112.

The second SFF system 104 may verify the authenticity of the information regarding the material 112 that has been retrieved (322). For instance, if the information is retrieved via a secure server connection to the material information server 108, then this connection provides the authentication of the information regarding the material 112. The material identifier is then stored in the store of material identifiers, and the information regarding the material 112 that has been retrieved is also stored (324).

The second SFF system 104 parses the retrieved information regarding the material 112 to, for instance, extract parameters regarding the material 112, and dynamically adjusts its own parameters based on parameters extracted (326). For example, if the information is retrieved in extensible Markup Language (XML) format, the second SFF system 104 parses the XML-formatted information to extract the parameters regarding the material 112 contained therein. These parameters regarding the material 112 are employed by the second SFF system 104 to adjust its own parameters so that physical objects can be properly fabricated from the material 112, as can be appreciated by those of ordinary skill within the art. The adjustment is dynamic in that it can occur while the second SFF system 104 is running, without having to reboot the second SFF system 104, and can also occur without user intervention and involvement.

The first SFF system 102 may further be sent the retrieved information regarding the material 112, or alternatively information as to how the information regarding the material 112 can be downloaded by the first SFF system 102 itself (328). In the latter instance, for example, the second SFF system 104 may provide the first SFF system 102 with the known base URL and/or the material identifier associated with the material 112. Therefore, the first SFF system 102 has sufficient information to download the information regarding the material 112 from the material information server 108 itself.

Regardless of whether the material identifier is known or unknown, as that determination was made in 304, the second SFF system 104 can periodically update the stored information regarding the material of each material identifier in the store (330). For example, the second SFF system 104 may update its stored information by downloading any newly released information from the material information server 108 for a particular material, if that material is to be imminently used for physical object fabrication. As another example, on a regular schedule the second SFF system 104 may update its stored information regarding the material of each material identifier in the store, to retain their currency.

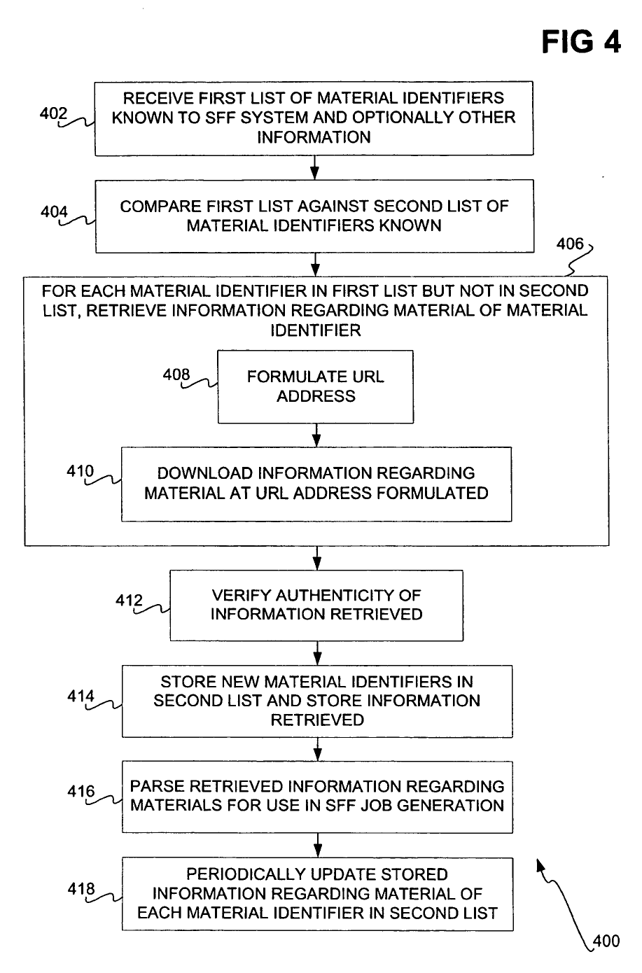

FIG. 4 shows a method 400 that is performable by the first SFF system 102, according to an embodiment of the invention. The first SFF system 102 is described as performing the method 400 relative to the second SFF system 104, the material information server 108, the material 112, and the network 106 of FIG. 1, for descriptive clarity. The method 400 may further be implemented as one or more computer program parts of a computer program stored on a computer-readable medium. The medium may be a recordable data storage medium, a modulated carrier signal, or another type of computer-readable medium.

The first SFF system 102 receives a first list of material identifiers known to the second SFF system 104 over the network 106, as well as optionally other information (402). Receiving the first list may involve the first SFF system 102 receiving the list as part of an information extraction process performed by the first SFF system 102 relative to the second SFF system 104. For instance, the first SFF system 102 may query the second SFF system 104 for information regarding the second SFF system 104. In response, the second SFF system 104 may provide the first SFF system 102 with information about itself, including a list of material identifiers known to the second SFF system 104. The second SFF system 104 may provide, for example, the known base URL address that has been described.

The first SFF system 102 compares this first list of material identifiers against a second list of material identifiers known to the first SFF system 102 and stored at the first SFF system 102 (404). For each material identifier that is in the first list but not in the second list, the first SFF system 102 retrieves information regarding the material associated therewith (406). In one embodiment, this can involve formulating a URL address (408), as has been described, and downloading the information at the URL address from the material information server 108 over the network 106 (410). The material information server 108 is thus a provider of this information other than the second SFF system 104. Alternatively, the first SFF system 102 may receive the information regarding each material identifier in the first list but not in the second list from the second SFF system 104 itself, over the network 106.

The first SFF system 102 further may verify the authenticity of the information that has been retrieved (412), in the same manner as has been described in relation to the second SFF system 104 verifying the authentication of the information it retrieves. The first SFF system 102 stores the new material identifiers in the second list, since they are now known to the first SFF system 102, and stores the information regarding the materials of these identifiers that has been retrieved (414). The first SFF system 102 then parses the information regarding the materials for using it in SFF fabrication job generation (416). Periodically, the first SFF system 102, like the second SFF system 104, may update the stored information regarding the material of each material identifier in the first list and/or the second list, so that the information remains current (418).

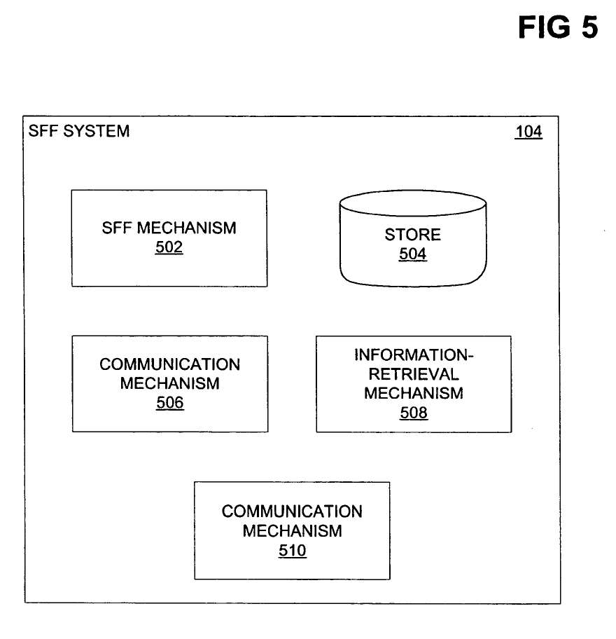

FIG. 5 shows a block diagram of the second SFF system 104 in detail, according to an embodiment of the invention. In one embodiment, the second SFF system 104 may also be referred to as an SFF server system, in that it receives SFF fabrication jobs from clients, such as the first SFF system 102. The second SFF system 104 is depicted in FIG. 5 as including an SFF mechanism 502, a store 504, a communication mechanism 506, an information-retrieval mechanism 508, and a communication mechanism 510. The second SFF system 104 may further include other components, in addition to and/or in lieu of those shown in FIG. 5. The description of FIG. 5 is made in relation to the various components of FIG. 1 for descriptive clarity, such as the first SFF system 102, the network 106, the material information server 108, the material container 110, the material 112, and the tag 114. The mechanisms 502, 506, and 508 may each be hardware or a combination of hardware and software.

The SFF mechanism 502 is the mechanism that actually fabricates a physical object directly from the CAD information of a SFF fabrication job received from the first SFF system 102, in a layer-by-layer manner. The SFF mechanism 502 may be one or more of a selective laser sintering mechanism, a stereo lithography mechanism, a wide-area thermal inkjet mechanism, a fused deposition modeling mechanism, a single jet inkjet mechanism, a three-dimensional printing mechanism, and/or a laminated object manufacturing mechanism, among other types of SFF mechanisms. The SFF mechanism 502 can fabricate the physical object from the material 112, since the parameters of the second SFF system 104 are dynamically adjustable based on the information regarding the material 112 retrieved from the material information server 108. These parameters are particularly the parameters of the SFF mechanism 502.

The store 504 may be a storage device such as a magnetic storage device, like a hard disk drive, a semiconductor storage device, like flash memory, or another type of storage device. The store 504 stores the unique material identifiers of materials for which the SFF mechanism 502 has information by which to adjust its parameters. The information may be stored by the SFF mechanism 502 within the store 504 as well.

The communication mechanism 506 receives the unique material identifier from the material container 110 containing the material 112 and that is presented to the second SFF system 104. The mechanism 506 may include an RF reader to detect signals returned by the tag 114 of the container 110, where the tag 114 is an RFID tag. The mechanism 506 may further include a bar code reader to scan a bar code of the tag 114, where the tag 114 is a bar code tag. Alternatively, the mechanism 506 may include a user input device, such as a keyboard, to receive manual user entry of the unique material identifier printed on the tag 114 of the material container 110.

The information-retrieval mechanism 508 may include network adapters and/or other types of communication technologies to communicate with the material information server 108 over the network 106, and may share these technologies with the communication mechanism 510, which communicates with the first SFF system 102 over the network 106. The mechanism 506 retrieves from the material information server 108 over the network 106 the information regarding the material 112 contained in the material container 110, where the material 112 is associated with a unique material identifier not present in the store 504. The SFF mechanism 502 is then able to dynamically adjust its parameters based on this information so that physical objects can be fabricated from the material 112. The mechanism 506 may formulate a URL address based on a known base URL address and the unique material identifier of the material 112, to download the information regarding the material 112, as has been described.

The communication mechanism 510 may further include network adapters and/or other types of communication technologies to communicate with the first SFF system 102 over the network 106, and these technologies may be shared with the information-retrieval mechanism 508, which communicates with the material information server 108 over the network 106. The mechanism 510 provides the first SFF system 102 with the actual information regarding the material 112, or with information regarding how the actual information regarding the material 112 can be retrieved, as has been described. For instance, the mechanism 510 may provide the first SFF system 102 with the known base URL and the unique material identifiers of its known material so that the first SFF system 102 can download the information from the material information server 108. Furthermore, the mechanism 510 receives from the first SFF system 102 SFF fabrication jobs over the network, where are provided to the SFF mechanism 502 for the fabrication of physical objects in accordance therewith.

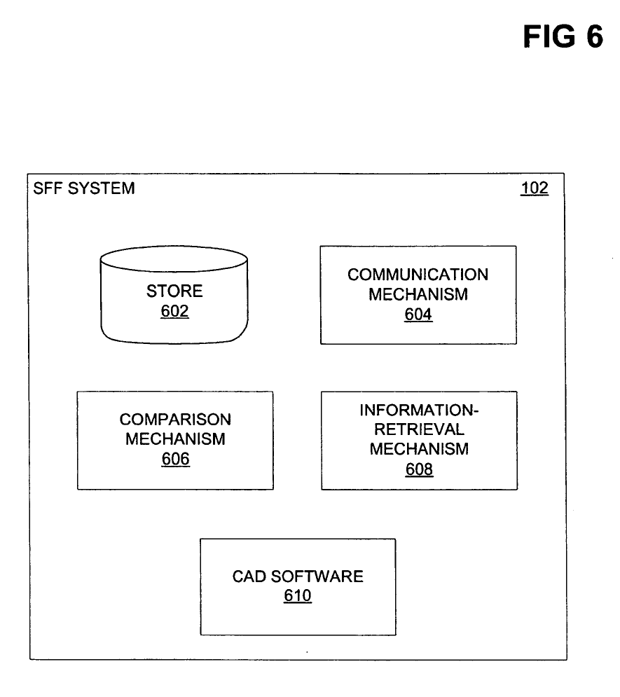

FIG. 6 shows a block diagram of the first SFF system 102 in detail, according to an embodiment of the invention. The first SFF system 102 may also be referred to as an SFF client system in one embodiment of the invention, in that it sends SFF fabrication jobs to the second SFF system 104. The first SFF system 102 is depicted in FIG. 6 as including a store 602, a communication mechanism 604, a comparison mechanism 606, an information retrieval mechanism 608, and CAD software 610. The first SFF system 102 may further include other components, in addition to and/or in lieu of those shown in FIG. 6. The description of FIG. 6 is made in relation to the various components of FIG. 1 for descriptive clarity, such as the second SFF system 104, the material information server 108, the material 112, and the network 106. The mechanisms 604 and 608 may be hardware, or a combination of hardware and software, whereas the mechanism 606 may be hardware, software, or a combination of hardware and software.

The store 602 may be a storage device such as a magnetic storage device, like a hard disk drive, a semiconductor storage device, like flash memory, or another type of storage device. The store 602 stores the unique material identifiers of materials known to the first SFF system 102 for which the CAD software 610 has information by which to generate SFF fabrication jobs for transmission to the second SFF system 104 over the network 106. The information may be stored by the CAD software 610 within the store 602 as well. The material identifiers stored in the store 602 are those indicated as being in the second list of the method 400 of FIG. 4.

The communication mechanism 604 may include network adapters and/or other types of communication technologies to communicate with the second SFF system 104 over the network 106, and may share these technologies with the information-retrieval mechanism 608. The communication mechanism 604 receives from the second SFF system 104 a list of unique material identifiers of materials known to the second SFF system 104. This list is the first list described in relation to the method 400 of FIG. 4. The communication mechanism 604 is also the mechanism by which the CAD software 610 sends SFF fabrication jobs to the second SFF system 104.

The comparison mechanism 606 compares the list of material identifiers received from the second SFF system 104 against the material identifiers stored in the store 602. Those material identifiers that are in the list received from the second SFF system 104, and thus known to the second SFF system 104, but that are not in the store 602, and thus are not known to the first SFF system 102, are sent to the information-retrieval mechanism 608. The information-retrieval mechanism 608 may include network adapters and/or other types of communication technologies to communicate with the second SFF system 104 and/or the material information server 108 over the network 106, and may share these technologies with the communication mechanism 604.

The information-retrieval mechanism 608 retrieves, from over the network 106, information regarding the material associated with each of the material identifiers presented to the mechanism 608 by the comparison mechanism 606. The information-retrieval mechanism 608 may retrieve this information directly from the second SFF system 104, or from the material information server 108. In the latter case, the mechanism 608 may formulate URL addresses as has been described to download the information regarding the materials from the material information server 108.

The CAD software 610 may be any type of computer-aided drafting software that is capable of generating SFF fabrication jobs. The term CAD is used in a general sense herein, and encompasses computer-aided engineering (CAE), computer-aided manufacturing (CAM), CAD/CAM, computer-aided drafting and design (CADD), computer-aided design, as well as other types of technologies. That is, the CAD software 610 may be any type of software that is capable of generating SFF fabrication jobs. The CAD software 610 generates a SFF fabrication job for fabrication from a specific material based on the information regarding that material which has been received. The CAD software 610 then sends the SFF fabrication job to the second SFF system 104 over the network 106 via the communication mechanism 604 of the first SFF system 102.

It is noted that, although specific embodiments have been illustrated and described herein, it will be appreciated by those of ordinary skill in the art that any arrangement is calculated to achieve the same purpose may be substituted for the specific embodiments shown. This application is intended to cover any adaptations or variations of the present invention. Therefore, it is manifestly intended that this invention be limited only by the claims and equivalents thereof.

1. A method comprising:
receiving a unique material identifier from a material container, by a solid freeform fabrication (SFF) system; and,
in response to determining at the SFF system that a material associated with the unique material identifier is unknown to the SFF system,
retrieving, at the SFF system, information regarding the material from over a network, based on the unique material identifier with which the material is associated.

2. The method of claim 1, wherein receiving the unique material identifier from the material container comprises detecting a signal transmitted by a radio-frequency identifier (RFID) tag on the material container, the signal encoding the unique material identifier.

3. The method of claim 1, wherein receiving the unique material identifier from the material container comprises scanning a bar code tag on the material container, the bar code tag having a bar code encoding the unique material identifier.

4. The method of claim 1, wherein receiving the unique material identifier from the material container comprises prompting a user to manually enter the unique material identifier.

5. The method of claim 1, further comprising determining at the SFF system whether the material associated with the unique material identifier is unknown to the SFF system.

6. The method of claim 5, wherein determining at the SFF system whether the material associated with the unique material identifier is unknown to the SFF system comprises:
looking up the unique material identifier in a store of known unique material identifiers;
where the unique material identifier is absent from the store of known unique material identifiers, concluding that the unique material identifier is unknown.

7. The method of claim 1, further comprising storing the unique material identifier in a store of known unique material identifiers.

8. The method of claim 7, further comprising updating stored information regarding a material of each of the known unique material identifiers by retrieving new information regarding the material from over the network, based on the unique material identifier with which the material is associated.

9. The method of claim 1, further comprising storing the information regarding the material retrieved.

10. The method of claim 1, wherein retrieving the information regarding the material from over the network comprises downloading the information regarding the material at a constant Uniform Resource Locator (URL) address, where the unique material identifier is containing within a payload of a request provided to the URL address.

11. The method of claim 1, wherein retrieving the information regarding the material from over the network comprises:
formulating a Uniform Resource Locator (URL) address based on a known base URL address and appending thereto the unique material identifier; and,
downloading the information regarding the material at the URL address formulated.

12. The method of claim 1, wherein retrieving the information regarding the material from over the network comprises downloading at least one of:
machine-readable information by which the SFF system is to be dynamically adjusted for utilization with the material; and,
human-readable information that the SFF system is capable of displaying to the user for user education regarding the material.

13. The method of claim 1, further comprising parsing the information regarding the material retrieved.

14. The method of claim 13, wherein parsing the information regarding the material retrieved comprises parsing one or more parameters regarding the material from the information regarding the material retrieved.

15. The method of claim 1, further comprising dynamically adjusting one or more parameters of the SFF system based on the information regarding the material retrieved.

16. The method of claim 1, further comprising verifying authenticity of the information regarding the material retrieved from over the network.

17. The method of claim 16, wherein verifying the authenticity of the information regarding the material retrieved from over the network comprises retrieving the information via a secure connection over the network, such that the secure connection provides authentication of the information regarding the material.

18. The method of claim 16, wherein verifying the authenticity of the information regarding the material retrieved from over the network comprises authenticating a file containing the information regarding the material, such that authenticating the file provides for authentication of the information regarding the material.

19. The method of claim 1, further comprising sending another system the information regarding the material.

20. The method of claim 1, further comprising sending another system information regarding how the information regarding the material can be retrieved from over the network.

21. The method of claim 1, wherein the SFF system is one or more of: a rapid prototyping system, a selective laser sintering system, a stereo lithography system, a wide-area thermal inkjet system, a fused deposition modeling system, a single jet inkjet system, a three-dimensional printing system, and a laminated object manufacturing system.

22. A solid freeform fabrication (SFF) system comprising:
an SFF mechanism to fabricate physical objects directly from computer-aided drafting (CAD) information in a layer-by-layer manner, the SFF mechanism having one or more parameters that are adjustable in accordance with materials from which the physical objects are fabricated;
a store of unique material identifiers of materials for which the SFF mechanism has information by which to adjust the one or more parameters;
a communication mechanism to receive unique material identifiers from material containers of materials presented to the SFF system; and,
a information-retrieval mechanism to retrieve from over a network information regarding the materials contained in the material containers for which the unique material identifiers are absent from the store of unique material identifiers, the SFF mechanism able to adjust the one or more parameters thereof based on the information regarding the materials retrieved.

23. The SFF system of claim 22, wherein the communication mechanism comprises a radio-frequency receiver to detect signals transmitted by radio-frequency identifier (RFID) tags on the material containers, the signals encoding the unique material identifiers of the materials contained in the material containers.

24. The SFF system of claim 22, wherein the communication mechanism comprises a bar code reader to scan bar code tags on the material containers, the bar code tags encoding the unique material identifiers of the materials contained in the material containers.

25. The SFF system of claim 22, wherein the communication mechanism comprises a user input device to receive from a user manual entry of unique material identifiers of the materials contained in the material containers.

26. The SFF system of claim 22, wherein the information-retrieval mechanism is to formulate Uniform Resource Locator (URL) addresses based on a known base URL address and appending thereto the unique material identifiers, such that the information regarding the materials is downloadable at the URL addresses formulated.

27. The SFF system of claim 22, further comprising a second communication mechanism to provide to one or more other systems at least one of:
the information regarding the materials retrieved; and,
information regarding how the information regarding the materials is able to be retrieved from over the network.

28. The SFF system of claim 22, wherein the SFF mechanism is one or more of: a rapid prototyping mechanism, a selective laser sintering mechanism, a stereo lithography mechanism, a wide-area thermal inkjet mechanism, a fused deposition modeling mechanism, a single jet inkjet mechanism, a three-dimensional printing mechanism, and a laminated object manufacturing mechanism.

29. A solid freeform fabrication (SFF) system comprising:
means for fabricating physical objects directly from computer-aided drafting (CAD) information in a layer-by-layer manner, based on one or more parameters that are adjustable in accordance with materials from which the physical objects are fabricated;
means for storing unique material identifiers of materials for which information has been retrieved and by which the one or more parameters are adjustable;
means for receiving unique material identifiers from material containers of materials presented to the SFF system; and,
means for retrieving from over a network information regarding the materials contained in the material containers for which the unique material identifiers are absent from the store of unique material identifiers.

30. The SFF system of claim 29, wherein the means for retrieving formulates Uniform Resource Locator (URL) addresses based on a known base URL address and appending thereto the unique material identifiers, such that the information regarding the materials is downloadable at the URL addresses formulated.

31. A computer-readable medium having a computer program stored thereon for execution at a solid freeform fabrication (SFF) system, the computer program comprising:
a first computer program part to retrieve information regarding a material associated with a unique material identifier on a material container and that is unknown to the SFF system, from over a network; and,
a second computer program part to adjust one or more parameters for fabricating physical objects from the material, based on the information regarding the material retrieved from over the network.

32. The medium of claim 31, wherein the first computer program part is to formulate a Uniform Resource Locator (URL) address based on a known base URL address and appending thereto the unique material identifier, such that the information regarding the material is downloadable at the URL address formulated.

33. A method comprising:
receiving by a first solid freeform fabrication (SFF) system, from a second SFF system over a network, first unique material identifiers of materials known to the SFF system;
comparing by the first SFF system the first unique material identifiers against second unique material identifiers of materials known to the first SFF system; and,
for each unique material identifier of a material present in the first unique material identifiers and absent from the second unique material identifiers,
retrieving, at the first SFF system, information regarding the material from over the network, based on the unique material identifier.

34. The method of claim 33, wherein receiving the first unique material identifiers comprises the first SFF system querying the second SFF system over the network.

35. The method of claim 33, wherein receiving the first unique material identifiers comprises the first SFF system receiving the first unique material identifiers as part of an information extraction process performed by the first SFF system relative to the second SFF system.

36. The method of claim 33, wherein retrieving the information regarding the material of each unique material identifier present in the first unique material identifiers and absent from the second unique material identifiers comprises the first SFF system retrieving the information directly from the second SFF system over the network.

37. The method of claim 33, wherein retrieving the information regarding the material of each unique material identifier present in the first unique material identifiers and absent from the second unique material identifiers comprises the first SFF system retrieving the information from a provider of the information other than the second SFF system, over the network.

38. The method of claim 33, wherein retrieving the information regarding the material of each unique material identifier present in the first unique material identifiers and absent from the second unique material identifiers comprises:
formulating a Uniform Resource Locator (URL) address based on a known base URL address and appending thereto the unique material identifier; and,
downloading the information regarding the material at the URL address formulated.

39. The method of claim 33, further comprising parsing the information regarding the material of each unique material identifier retrieved.

40. The method of claim 33, further comprising verifying authentication of the information regarding the material of each unique material identifier retrieved from over the network.

41. The method of claim 33, further comprising updating stored information regarding a material of each of the known unique material identifiers of the second unique material identifiers by retrieving new information regarding the material from over the network, based on the unique material identifier with which the material is associated.

42. A solid freeform fabrication (SFF) system comprising:
a store of unique material identifiers of materials known to the SFF system;
a communication mechanism to receive, from a second SFF system communicatively coupled to the SFF system over a network, unique material identifiers of materials known to the second SFF system;
a comparison mechanism to compare the unique material identifiers received from the second SFF system against the unique material identifiers of the store; and,
an information-retrieval mechanism to retrieve from over the network information regarding materials having unique material identifiers in the unique material identifiers received from the second SFF system that are absent from the store of unique material identifiers.

43. The SFF system of claim 42, wherein the information-retrieval mechanism is to retrieve the information regarding the materials directly from the second SFF system over the network.

44. The SFF system of claim 42, wherein the information-retrieval mechanism is to retrieve the information regarding the materials from a provider of the information other than the second SFF system, over the network.

45. The SFF system of claim 42, wherein the information-retrieval mechanism is to formulate Uniform Resource Locator (URL) addresses based on a known base URL address and appending thereto the unique material identifiers, such that the information regarding the materials is downloadable at the URL addresses formulated.

46. A solid freeform fabrication (SFF) system comprising:
means for receiving, from a second SFF system communicatively coupled to the SFF system over a network, unique material identifiers of materials known to the second SFF system;
means for comparing the unique material identifiers of materials known to the second SFF system against unique material identifiers of materials known to the SFF system; and,
means for retrieving from over the network information regarding materials having unique material identifiers known to the second SFF system but not to the SFF system.

47. The SFF system of claim 46, wherein the means for retrieving retrieves the information directly from the second SFF system, over the network.

48. The SFF system of claim 46, wherein the means for retrieving retrieves the information from a provider of the information other than the second SFF system, over the network.

49. The SFF system of claim 46, wherein the means for retrieving formulates Uniform Resource Locator (URL) addresses based on a known base URL address and appending thereto the unique material identifiers, such that the information regarding the materials is downloadable at the URL addresses formulated.

50. A computer-readable medium having a computer program stored thereon for execution at a solid freeform fabrication (SFF) system, the computer program comprising:
a first computer program part to compare unique material identifiers of materials known to a second SFF system received over a network from the second SFF system to unique material identifiers known to the SFF system; and,
a second computer program part to retrieve information regarding a material associated with each unique material identifier known to the second SFF system but not known to the SFF system, from over a network.

51. The medium of claim 50, wherein the second computer program part is to formulate a Uniform Resource Locator (URL) address based on a known base URL address and appending thereto the unique material identifier, such that the information regarding the material is downloadable at the URL address formulated.
